(19) United States
(12) Patent Application Publication
(10) Pub. No.: US 2015/0310393 A1
(43) Pub. Date: Oct. 29, 2015

(54) METHODS FOR IDENTIFYING A BEST FIT CANDIDATE FOR A JOB AND DEVICES THEREOF

(71) Applicant: Wipro Limited, Bangalore (IN)

(72) Inventors: Sindhu Bhaskaran, Bangalore (IN); Abhishek Soni, Pune (MH)

(21) Appl. No.: 14/299,784

(22) Filed: Jun. 9, 2014

(30) Foreign Application Priority Data
Apr. 29, 2014 (IN) 2153/CH/2014

(51) Int. Cl. G06Q 10/10; G06Q 50/00

(52) U.S. Cl. CPC G06Q 10/1053; G06Q 50/01

(57) ABSTRACT

A method, non-transitory computer readable medium, and device that identify a best fit candidate for a job in an organization includes receiving company specific data and job specific data. A company profile and a job profile are created using the received company specific data and job specific data. Data pertaining to all candidates are obtained from the company and other external sources and used to fill a candidate profile for each of the candidates. A job influence score, company fitment score and a job fitment score is calculated for each candidate. A total candidate job score is calculated based on the calculated job influence score, company fitment score and the job fitment score. All the candidates are then ranked based on the calculated total candidate job score.

This application claims the benefit of Indian Patent Application No. 2153/CHE/2014 filed Apr. 29, 2014, which is hereby incorporated by reference in its entirety.

### FIELD

This disclosure generally relates to methods and devices for assisting with candidate recruitment for a job and, more specifically, to a method for identifying the best fit candidate for a job and devices thereof.

### BACKGROUND

This is the era of internet and social media where prospective employees are sharing a lot of data about themselves through various job portals, social networking sites, blogs, web-sites by way of example only. Moreover multiple external or Government or financial databases also gather a lot of information about individuals. If the prospective candidate in question is an internal candidate of that organization itself, then a lot of information is already available on the internal organization sites, like Human Resources, Appraisal, and Financial databases. Companies using traditional recruitment process find it time-consuming to screen hundreds of resumes and also the huge amount of information available about the candidate on the web and social media to find the most suitable candidate for the Job. Additionally, currently there is no automated way to analyze and effectively use the huge amount of information available about a candidate on the various external databases mentioned above, in order to recruit the right candidate for the job.

While candidates are explicitly sharing lots of information about themselves on the World Wide Web, the information companies objectively analyze now is limited to what is shared on the Job Portals or in received resumes, which is sometimes out of date. It is very important for the organizations to analyze all the information available at their disposal during the screening and selection process itself in order to avoid hiring the wrong candidate which would result in wastage of time, effort and costs.

### SUMMARY

A method for identifying a best fit candidate for a job in an organization includes receiving, at a candidate management computing device, company specific data and job specific data. A company profile and a job profile are created at the candidate management computing device using the received company specific data and job specific data. Data pertaining to all candidates are obtained from the company and other external sources and used to fill a candidate profile for each of the candidates. A job influence score, company fitment score and a job fitment score is calculated by the candidate management computing device for each candidate. A total candidate job score is calculated by the candidate management computing device based on the calculated job influence score, company fitment score and the job fitment score. All the candidates are then ranked by the candidate management computing device based on the calculated total candidate job score.

A non-transitory computer readable medium having stored thereon instructions for identifying the best fit candidate for a job in an organization comprising machine executable code which when executed by a processor, causes the processor to perform steps including receiving candidate management computing device company specific data and job specific data. A company profile and a job profile are created by the candidate management computing device using the received company specific data and job specific data. Data pertaining to all candidates are obtained from the company and other external sources and used to fill a candidate profile for each of the candidates. A job influence score, company fitment score and a job fitment score is calculated by the candidate management computing device for each candidate. A total candidate job score is calculated by the candidate management computing device based on the calculated job influence score, company fitment score and the job fitment score. All the candidates are then ranked by the candidate management computing device based on the calculated total candidate job score.

A candidate management computing device, comprising a memory and a processor coupled to the memory and configured to execute programmed instructions stored in the memory including receiving, at a candidate management computing device company specific data and job specific data. A company profile and a job profile are created at the candidate management computing device using the received company specific data and job specific data. Data pertaining to all candidates are obtained from the company and other external sources and used to fill a candidate profile for each of the candidates. A job influence score, company fitment score and a job fitment score is calculated by the candidate management computing device for each candidate. A total candidate job score is calculated by the candidate management computing device based on the calculated job influence score, company fitment score and the job fitment score. All the candidates are then ranked by the candidate management computing device based on the calculated total candidate job score.

It is to be understood that both the foregoing general description and the following detailed description are exemplary and explanatory only and are not restrictive of the invention, as claimed.

### BRIEF DESCRIPTION OF DRAWINGS

FIG. 1 is a diagram of an exemplary environment with the candidate management computing device configured to identify a best fit candidate for a job

FIG. 2 is a diagram of the candidate management computing device configured to identify a best fit candidate for a job; FIG. 2 is a block diagram of the exemplary candidate management computing device illustrated in FIG. 1;

FIG. 3 is a flow chart of an example of a method for identifying a best fit candidate for a job in accordance with some embodiments;

FIG. 4 is a flowchart of an example of a method for calculating a job influence score for a candidate;

FIG. 5 is a flowchart of an example method for calculating a company fitment score for a candidate; and

FIG. 6 is a flowchart of an example method for calculating a job fitment score for a candidate.

### DETAILED DESCRIPTION

Now, exemplary embodiments of the present disclosure will be described with reference to the accompanying drawings. Wherever possible, the same reference numbers will be used throughout the drawings to refer to the same or like parts. While exemplary embodiments and features are described herein, modifications, adaptations, and other implementations are possible, without departing from the spirit and scope of the disclosure. Accordingly, the following detailed description does not limit the subject matter. Instead, the proper scope of the subject matter is defined by the appended claims.

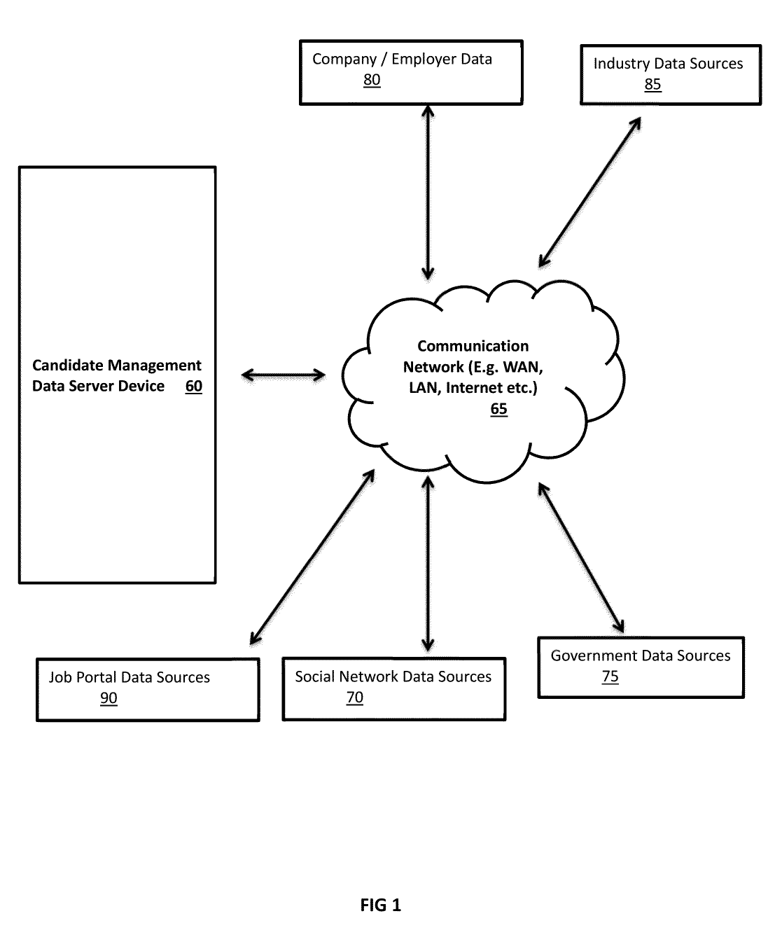

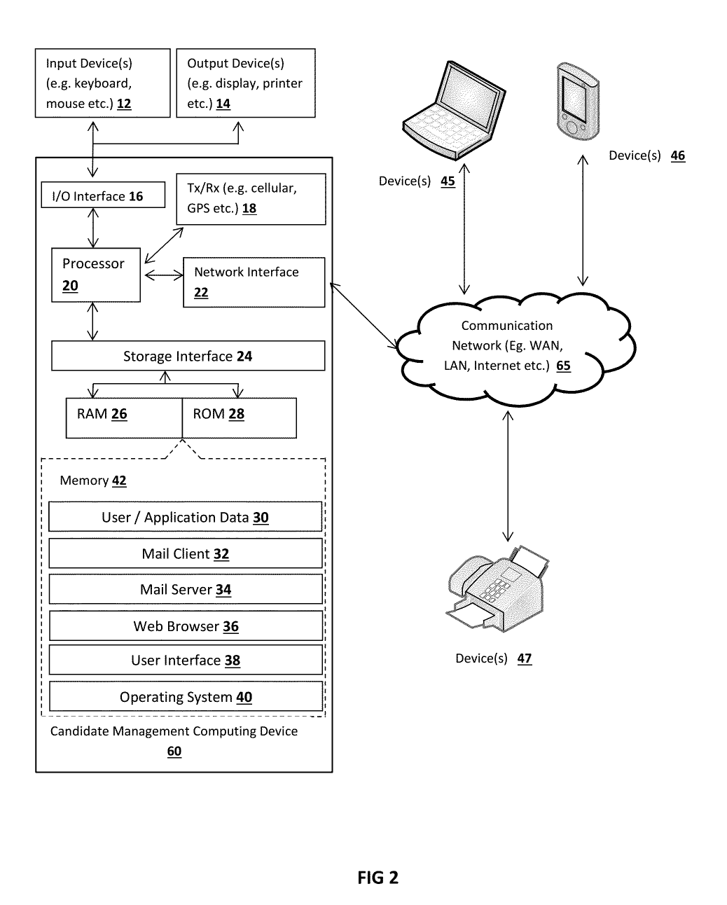

FIG. 1 is a diagram of an exemplary environment with a candidate management computing device 60 configured to identify a best fit candidate for a job. The candidate management computing device is one of the possible variations of the candidate management computing device 60 described in greater detail below with reference to FIG. 2. The example of an environment described here includes the candidate management computing device 60 being connected to the communication network 65 in a variation of some of the mentioned methods described in greater detail herein with reference to FIG. 2. The candidate management computing device is further connected to multiple candidate data sources like the social network data source 70, job portal data source 90, industry based data source 85, government data source 75 and candidate data source 80 collected by the company or other entity itself, through the communication network 65, although the candidate management computing device could be connected to other types and/or numbers of sources. The candidate management computing device then receives through the communication network 65, data regarding the candidates from one or more of the above mentioned multiple sources. This data is further analyzed by the candidate management computing device and a total candidate job score for each of the candidates is calculated, which is based on individually calculated job influence score, company fitment score and a job fitment score for each of the candidates, although other types and/or numbers of other scores may also be used for determining the total candidate job score. The candidate management computing device further ranks all the candidates in order based on the calculated total candidate job score.

FIG. 2 is a block diagram of an example of the candidate management computing device 60 configured to identify a best fit candidate for a job, although other types and/or numbers of other computer systems could be used candidate management computing device. Candidate management computing device 60 may comprise a central processing unit (“CPU” or “processor”) 20. Processor 20 may comprise at least one data processor for executing program components for executing user- or system-generated requests. A user may include a person, a person using a device, such as such as those included in this disclosure, or such a device itself. The processor 20 may include specialized processing units such as integrated system (bus) controllers, memory management control units, floating point units, graphics processing units, digital signal processing units, by way of example only. The processor 20 may include a microprocessor, such as AMD Athlon, Duron or Opteron, ARM's application, embedded or secure processors, IBM PowerPC, Intel's Core, Itanium, Xeon, Celeron or other line of processors, by way of example only. The processor 20 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), by way of example only.

Processor 20 may be disposed in communication with one or more input/output (I/O) devices via I/O interface 16. The I/O interface 16 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), by way of example only.

Using the I/O interface 16, the candidate management computing device 60 may communicate with one or more I/O devices. For example, the input device 12 may be an antenna, keyboard, mouse, joystick, (infrared) remote control, camera, charge-coupled device (CCD), card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, by way of example only. Output device 14 may be a printer, fax machine, video display (e.g., cathode ray tube (CRT), liquid crystal display (LCD), light-emitting diode (LED), plasma, or the like), audio speaker, by way of example only. In some embodiments, a transceiver 18 may be disposed in connection with the processor 20. The transceiver 18 may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, by way of example only.

In some embodiments, the processor 20 may be disposed in communication with a communication network 65 via a network interface 22. The network interface 22 may communicate with the communication network 65. The network interface 22 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, by way of example only. The communication network 65 may include, without limitation, a direct interconnection, local area network (LAN), wide area network (WAN), wireless network (e.g., using Wireless Application Protocol), the Internet, by way of example only. Using the network interface 22 and the communication network 65, the candidate management computing device 60 may communicate with devices 45, 46, and 47. These devices may include, without limitation, personal computer(s), server(s), fax machines, printers, scanners, various mobile devices such as cellular telephones, smartphones (e.g., Apple iPhone, Blackberry, Android-based phones, by way of example only), tablet computers, eBook readers (Amazon Kindle, Nook, by way of example only), laptop computers, notebooks, gaming consoles (Microsoft Xbox, Nintendo DS, Sony PlayStation, by way of example only), or the like. In some embodiments, the candidate management computing device 60 may itself embody one or more of these devices.

In some embodiments, the processor 20 may be disposed in communication with one or more memory devices (e.g., RAM 26, ROM 28, by way of example only) via a storage interface 24. The storage interface 24 may connect to memory devices including, without limitation, memory drives, removable disc drives, by way of example only, employing connection protocols such as serial advanced technology attachment (SATA), integrated drive electronics (IDE), IEEE-1394, universal serial bus (USB), fiber channel, small computer systems interface (SCSI), by way of example only. The memory drives may further include a drum, magnetic disc drive, magneto-optical drive, optical drive, redundant array of independent discs (RAID), solid-state memory devices, solid-state drives, by way of example only.

The memory devices comprise a memory 42 that may store a collection of program, database components, and/or other data including, by way of example only and without limitation, an operating system 40, user interface application 38, web browser 36, mail server 34, mail client 32, user/application data 30 (e.g., any data variables or data records discussed in this disclosure), although other types and/or numbers of other programmed instructions, modules, and/or other data may be stored The operating system 40 may facilitate resource management and operation of the candidate management computing device 60. Examples of operating systems include, without limitation, Apple Macintosh OS X, Unix, Unix-like system distributions (e.g., Berkeley Software Distribution (BSD), FreeBSD, NetBSD, OpenBSD, by way of example only), Linux distributions (e.g., Red Hat, Ubuntu, Kubuntu, by way of example only), IBM OS/2, Microsoft Windows (XP, Vista/7/8, by way of example only), Apple iOS, Google Android, Blackberry OS, or the like. User interface 38 may facilitate display, execution, interaction, manipulation, or operation of program components through textual or graphical facilities. For example, user interfaces may provide computer interaction interface elements on a display system operatively connected to the candidate management computing device 60, such as cursors, icons, check boxes, menus, scrollers, windows, widgets, by way of example only. Graphical user interfaces (GUIs) may be employed, including, without limitation, Apple Macintosh operating systems' Aqua, IBM OS/2, Microsoft Windows (e.g., Aero, Metro, by way of example only), Unix X-Windows, web interface libraries (e.g., ActiveX, Java, Javascript, AJAX, HTML, Adobe Flash, by way of example only), or the like.

In some embodiments, the candidate management computing device 60 may implement a web browser 36 stored program component. The web browser 36 may be a hypertext viewing application, such as Microsoft Internet Explorer, Google Chrome, Mozilla Firefox, Apple Safari, by way of example only. Secure web browsing may be provided using HTTPS (secure hypertext transport protocol), secure sockets layer (SSL), Transport Layer Security (TLS), by way of example only. Web browser 36 may utilize facilities, such as AJAX, DHTML, Adobe Flash, JavaScript, Java, application programming interfaces (APIs), by way of example only. In some embodiments, the candidate management computing device 60 may implement a mail server 34 stored program component. The mail server may be an Internet mail server, such as Microsoft Exchange, although other types and/or numbers of mail server systems may be used. The mail server may utilize facilities such as ASP, ActiveX, ANSI C++/C#, Microsoft .NET, CGI scripts, Java, JavaScript, PERL, PHP, Python, WebObjects, by way of example only. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the candidate management computing device 60 may implement a mail client 32 stored program component. The mail client 32 may be a mail viewing application, such as Apple Mail, Microsoft Entourage, Microsoft Outlook, Mozilla Thunderbird, by way of example only.

In some embodiments, candidate management computing device 60 may store user/application data 30, such as the data, variables, records, by way of example only. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, by way of example only). Such databases may be consolidated or distributed, sometimes among the various computer systems discussed above in this disclosure. It is to be understood that the structure and operation of the any computer or database component may be combined, consolidated, or distributed in any working combination.

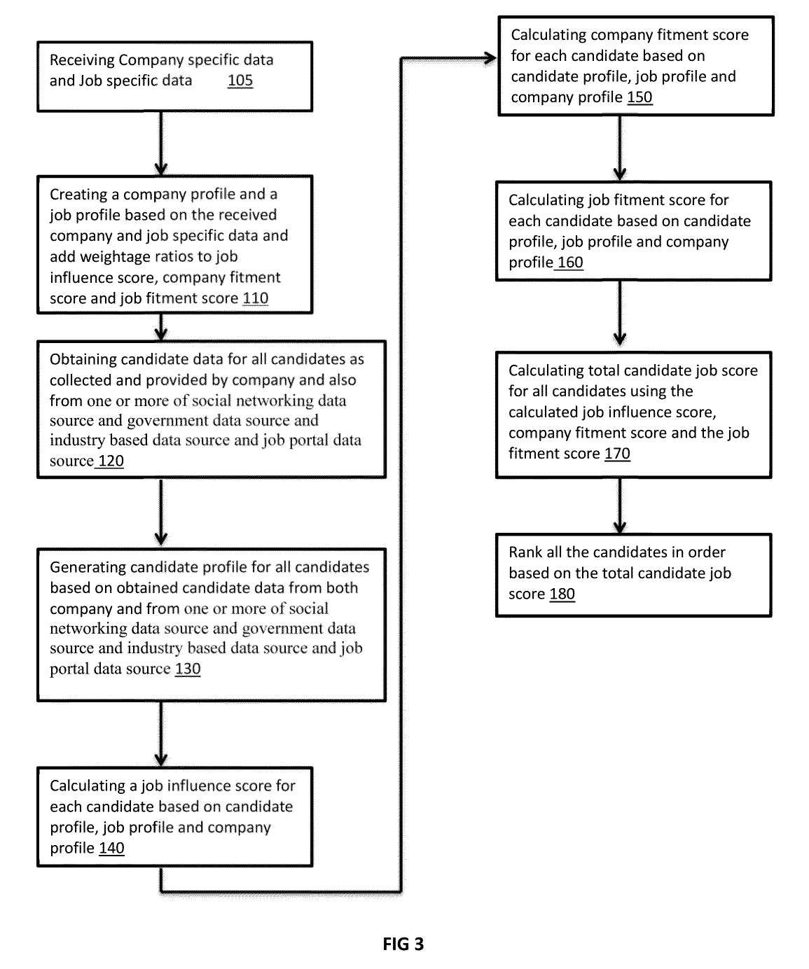

An exemplary method for identifying a best fit candidate for a job will now be described with reference to FIGS. 1-6. The exemplary method comprises calculating a job influence score, a company fitment score and a job fitment score by the candidate management computing device 60 for a plurality of candidates, based on a job profile, a company profile and a candidate profile. The exemplary method further comprises calculating a total candidate job score for each of the plurality of candidates, based on the calculated job influence score, company fitment score and job fitment score and then ranking the candidates in order based on the calculated total candidate job score. The exemplary method begins at step 105 of FIG. 3 where the candidate management computing device 60 receives a company specific data and a job specific data from the company or employer side. The company or the employer provides the company specific data and job specific data to the candidate management computing device 60 through standard communication network 65 like the internet, telecommunication lines using a web portal or a typical stand-alone application that is housed within the company premises and having access to the company's internal data and applications. In some embodiments, the candidate management computing device 60 may store data like a database which includes but not restricted to, company data, job data and candidate data. The candidate management computing device 60 will also act as a database storing the results of all the data transformation and score calculations for reporting to the company or employer. As an example the company specific data can include at least one of information specific to the company or employer like the type of a company, size of the company, geographical location, the type of service offerings that the company provides and the technology domain that the company operates in. Based on the provided company specific data, the candidate management computing device 60 first registers the company or employer in the database and then subsequently creates a company profile based on the provided company specific data as described in step 110 of FIG. 3.

Post the creation of the company profile, the candidate management computing device 60 creates a job profile as described in step 110 of FIG. 3, based on the job specific data provided by the company or employer. As an example, job specific data can include at least one of a job description, a skill level required for the job, a minimum required education level, an experience level in number of years of work experience and a geographical location of the job. Creation of a job profile by the candidate management computing device 60 further includes tuning the calculation of the total candidate job score by applying weightage ratios, like for example X, Y and Z percentages, to each of the company influence score, job fitment score and company fitment score, which are provided by the company or employer as an input.

An example of calculating the total candidate job score is by computing it based on the calculated job influence score, company fitment score and job fitment score having weightage ratios assigned to each one of them, although other approaches for calculating the total candidate job score may be used. An example would be the candidate management computing device 60 computing the total candidate job score using a formula (X*Job Influence Score)+(Y*Company Fitment Score)+(Z*Job Fitment Score) where X, Y and Z would be the weightage ratios in percentages input by the company or employer.

As described in step 120 of FIG. 3, candidate data for each of the plurality of candidates is obtained by the candidate management computing device 60 based on which the candidate profile is created. As an example, candidate data can include data collected or obtained by the company or employer and provided to the candidate management computing device 60, like at least one of an interviewer feedback of a candidate, a candidate resume and a company evaluation data of a candidate. Additionally, by way of an example, the candidate data can also include data collected by the candidate management computing device 60 about the candidate, from one or more of a social networking data source, government data source, industry data source and a job portal data source.

As an example, the candidate management computing device 60 initially collects candidate data for each of the plurality of the candidates from one or more of social networking data source like but not restricted to, LinkedIn®, Twitter®, Facebook®, and/or Internet blogs based on the candidate identity. Next, the candidate management computing device 60 collects candidate data from government data sources, job portal data sources and industry data sources based on the candidate identity. As an example, government data sources and industry data sources could be government regulatory bodies or industrial consortiums that have members or employees from multiple organizations discussing or working on different technology domain issues. Similarly, as an example, job portal data sources could include portals like but not restricted to Monster®, Naukri®, Dice®, CareerBuilder®, and/or GlassDoor™. The candidate management computing device 60 collects candidate data from these various data sources on areas that include papers, books published by the candidate, intellectual property like patents created, conferences attended or spoken in, patents filed, membership to technology groups, number of followers, and recommendations received using standard well known data analysis and semantic analysis and sentiment analysis techniques by matching pre-set relevant keywords to collected data. Additionally, the candidate management computing device also receives candidate data that has been collected by the company or employer in the form of interviewer feedback and company internal data sources. As an example the interviewer feedback can include technical assessment of candidate, behavioral attributes necessary for the job. As an example, if a candidate is an already existing internal employee of the company or employer, the candidate management computing device 60 receives candidate data based on the company's past evaluations or appraisals of the candidate.

Next, the candidate management computing device analyzes the collected candidate data from social networking data sources, like LinkedIn®, Facebook®, Twitter® and internet blogs by way of example only and identifies a list of people references relevant to the technical domain area of interest and the job description provided. By way of example only, the top three people references can be identified based on the requirements mentioned above. This analysis is done using standard techniques like semantic analyzer and natural language processors and the identified people references are sent an email reference form through standard internet communication means for them to provide references and recommendations about the candidate. The candidate management computing device 60 then receives the filled up response from these people references to the sent reference forms and retrieves the candidate data from the filled up reference forms by using standard data analysis and semantic analysis. Based on the totality of the candidate data collected from multiple sources mentioned above, the candidate management computing device 60 creates a candidate profile for each of the plurality of candidates as described in step 130 of FIG. 3.

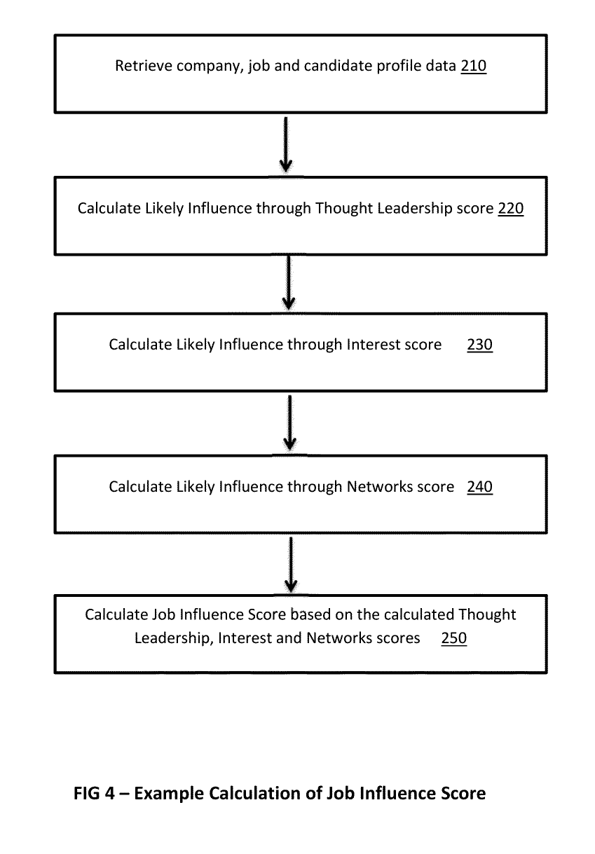

Post the creation of the candidate profile for each of the plurality of the candidates, the candidate management computing device 60 calculates a job influence score for each of the candidates based on the created company profile, job profile and the candidate profile, as illustrated and described with an example in FIG. 4. In some embodiments, the candidate management computing device 60 first retrieves the created company profile, job profile and the candidate profile as shown in step 210. Next, the candidate management computing device 60 calculates the Likely Influence through Thought Leadership score for each candidate, which is based on the data present in the retrieved company profile, job profile and candidate profile, although other approaches for determining this score using other types and/or numbers of profiles and/or other data could be used. As an example, by running a standard semantic analyzer, sentiment analyzer and specified keyword searches on the retrieved candidate profile data while comparing to the company and job profile, relevant domain and technology areas for the job and company are identified. Next, as an example, the candidate management computing device 60 calculates the Likely Influence by Thought Leadership Score based on a formula which is computing a Score A which is a summation of parameters derived from the candidate profile which is described as (number of papers and books+number of intellectual property assets+number of blogs or internet articles written+number of conferences spoken) in the identified relevant domain and technology areas, although other approaches for determining this score can be used. Score A is then summed with a Score B, which is defined by the formula ((number of followers on a site like Twitter®/1000)+(number of positive tweets)), to calculate the Likely Influence by Thought Leadership score as described in step 220, although other types and/or numbers of scores might be used to obtain this score.

Next, the candidate management computing device calculates the Likely Influence through Interest score for each candidate, which is based on the data present in the retrieved company profile, job profile and candidate profile. As an example, by running a standard semantic analyzer, sentiment analyzer and specified keyword searches on the retrieved candidate profile data while comparing to the company and job profile, relevant domain and technology areas for the job and company are identified. Next, as an example, the candidate management computing device 60 calculates the Likely Influence by Interest Score based on a formula which is computing a score A1 which is a summation of parameters derived from the candidate profile which is described as (number of groups the candidate is present in, having positive responses+number of conferences participated) in the identified relevant domain and technology areas. Score A1 is then summed with a Score B1, which is defined by the formula ((number of followers on a site like Twitter®/1000)+(number of companies or employers followed)), to calculate the Likely Influence by Interest score as described in step 230.

Next, the candidate management computing device calculates the Likely Influence through Networks score for each candidate, which is based on the data present in the retrieved company profile, job profile and candidate profile. As an example, by running a standard semantic analyzer, sentiment analyzer and specified keyword searches on the retrieved candidate profile data while comparing to the company and job profile, relevant domain and technology areas for the job and company are identified. Next, the candidate management computing device 60 calculates a score A2 based on the number of contact connections, covering both direct and indirect connections, that the candidate has on a social network site, like LinkedIn® by way of example only, and the presence of CXO designations, like CTO (Chief Technical Officer) or CEO (Chief Executive Officer) or CFO (Chief Financial Officer) by way of example only, in those connections. By way of example only, the candidate management computing device can go up to the connections for a candidate 4 levels away. The score A2 is computed as a summation of parameters using a formula, defined by way of an example, (W1*Number of direct connections in related domain+W2*Number of indirect connections in related domain+W3*Number of CXO level direct connections in relevant domain+W4*Number of COX level indirect connections in relevant domain) where W1, W2, W3 and W4 are defined weightage ratios, like 1/500, 1/5000, 1/10 and 1/100 as examples, although other approaches for determining this score can be used. Next, the candidate management computing device calculates a score B2, based on the recommendations provided by the candidate's connections on a social network site, like LinkedIn® by way of example only, which are analyzed by a standard sentiment analyzer, semantic analyzer and specific keyword searches, although other approaches for determining this score can be used. As an example, the score B2 is computed using the formula ((W1*total number of positive recommendations/total recommendations by connections)+(W2*total number of positive recommendations by CXO type connections/total recommendations by CXO type connections)) where W1 and W2 are defined weightage ratios like 5, 10 by way of an example. Next, the candidate management computing device 60 calculates a score C2 based on the candidate's connections on a social networking site, like LinkedIn® up to 4 levels away, by way of an example. The score C2 is computed by the candidate management computing device 60 using the formula (W1*total number of connections up to 4 levels away) where W1 is a defined weightage ratio like 1/50000 by way of an example, although other approaches for determining this score can be used. Now, the candidate management computing device 60 calculates the Likely Influence through Networks score as a summation of the individual scores of A2, B2 and C2 as described in step 240, although other approaches for determining this score can be used. Post the calculation of the Likely Influence through Thought Leadership score, Likely Influence through Interest score and the Likely Influence through the Network score by the candidate management computing device 60 for each of the plurality of the candidates, the Job Influence score for each of the candidates is calculated as a summation of the Likely Influence through Thought Leadership score, Likely Influence through Interest score and the Likely Influence through the Network score as described in step 250, although other approaches for determining this score can be used.

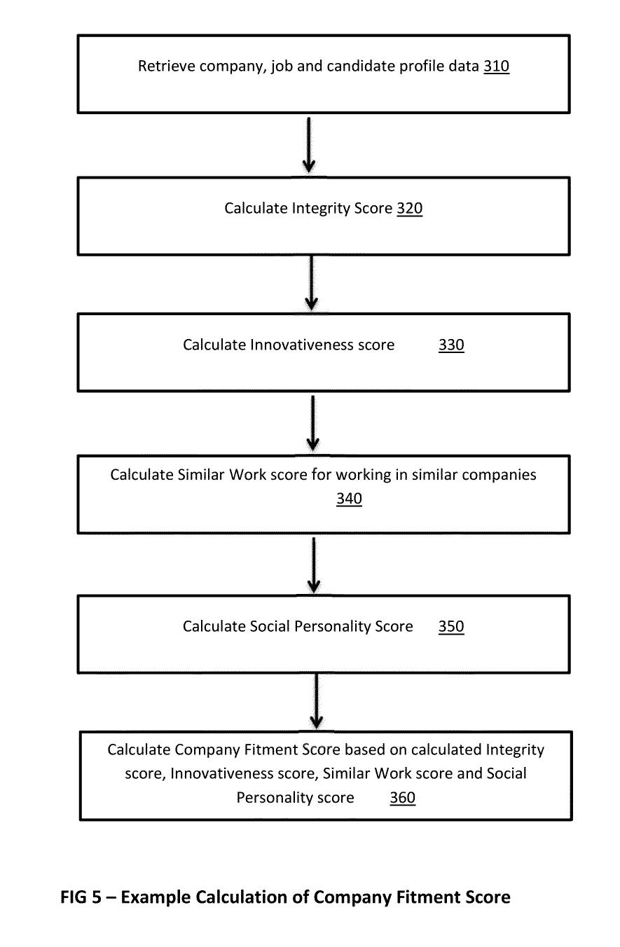

Post the calculation of the job influence score for each of the plurality of the candidates, the candidate management computing device 60 calculates a company fitment score for each of the candidates based on the created company profile, job profile and the candidate profile, as described in FIG. 5. In some embodiments, the candidate management computing device 60 first retrieves the created company profile, job profile and the candidate profile as shown in step 310. Next, the candidate management computing device 60 calculates the Integrity score for each of the candidates based on the data present in the retrieved company profile, job profile and candidate profile. As an example, by running a standard semantic analyzer, sentiment analyzer and specified keyword searches on the retrieved candidate profile data while comparing to the company and job profile, relevant domain and technology areas for the job and company are identified. Next, as an example, the candidate management computing device 60 calculates the Integrity Score for each of the plurality of the candidates as a summation of parameters like references checked, background information verified and company evaluation data for internal candidates, using the formula (A1+B1+C1) as described in step 320, where A1 is a measure of the number of positive feedback from the total number of references provided by the candidate, B1 is a measure of candidate being enrolled in government and industry databases like National Skills Registry in India and having a positive feedback and C1 is a measure for the candidate's internal company evaluation data and attendance data, although other approaches for determining this score can be used. As an example, B1 is computed using the formula (value x if enrolled in government or industry databases and has a negative background, value y in enrolled and if candidate has a positive background, value z if not enrolled in government or industry databases where x<z<y and all of them are numbers). As an example, C1 is computed using the formula ((value x*number of appraisal ratings where rating is equal to or greater than GOOD)+(value y*number of appraisal ratings where rating is equal to or greater than AVERAGE)+attendance %*z) where x is a number >than y and z is 1/10. The measure C1 will only exist in the cases where the candidate is an internal candidate of the company or employer already and company evaluation data of that candidate is available. In the event, where the candidate is not an internal candidate, measure C1 is not calculated and provided no value and the Integrity Score will be computed using the formula (A1+B1) only.

Post the calculation of the Integrity Score for each of the plurality of the candidates, the candidate management computing device calculates an Innovativeness score for each of the candidates based on the created company profile, job profile and the candidate profile, as described in FIG. 5. In some embodiments, the candidate management computing device 60 first retrieves the created company profile, job profile and the candidate profile as shown in step 310. Next, the candidate management computing device 60 calculates the Innovativeness score for each of the candidates based on the data present in the retrieved company profile, job profile and candidate profile. As an example, by running a standard semantic analyzer, sentiment analyzer and specified keyword searches on the retrieved candidate profile data while comparing to the company and job profile, relevant domain and technology areas for the job and company are identified along with candidate parameters like skills, expertise, previous work done, awards and recognition, certifications. Next, as an example, the candidate management computing device 60 calculates the Innovativeness Score based on the formula (A2+B2+C2), where: A2 is computed by (value x*number of skills, roles, companies for the candidate in the relevant domain); B2 is computed by (value y*number of awards, recognition received by candidate in relevant domain); and C2 is computed by (value z*number of papers published, IP owned and certifications done by candidate in relevant domain) where x is a number <y and z, although other approaches for determining this score can be used. The candidate management computing device 60 calculates the Innovativeness score for each of the plurality of the candidates based on the formula (A2+B2+C2) as described in step 330.

Post the calculation of the Innovativeness Score for each of the plurality of the candidates, the candidate management computing device 60 calculates a Similar Work score for each of the candidates based on the created company profile, job profile and the candidate profile, as described in FIG. 5. In some embodiments, the candidate management computing device 60 first retrieves the created company profile, job profile and the candidate profile as shown in step 310. Next, the candidate management computing device 60 calculates the Similar Work score for each of the candidates based on the data present in the retrieved company profile, job profile and candidate profile, although other approaches for determining this score can be used. As an example, by running a standard semantic analyzer, sentiment analyzer and specified keyword searches on the retrieved candidate profile data while comparing to the company and job profile, relevant domain and technology areas for the job and company are identified along with candidate parameters like skills, expertise, previous companies worked for, locations of previous companies that match with the company's locations and company culture fit. Next, as an example, the candidate management computing device 60 calculates the Similar Work Score based on the formula (A3+B3+C3+D3), where: A3 is computed by (value x*(number of relevant domain and technology areas+number of matching locations)); B3 is computed by (value x*number of matched previously worked company profiles with the company); and C3 which is computed based on the total tenure of the candidate in the previously worked companies in relevant domain and technology areas, using the formula (C3=0 if total tenure is <24 months or C3=10 if total tenure is >=24 months and <=60 months or C3=20 if total tenure is >60 months and <=120 months or C3=30 if total tenure is >120 months) where x is a typical positive number like 10; and. D3 is computed using the formula (value x*Organization Culture Fit score) where Organization Culture Fit score is a standard 40 point profile mapping created to take the inputs from candidate in the form of feedback or questionnaires, to analyze the organization's culture of the candidate's preference, although other approaches for determining this score can be used. A typical Q-Sort method is used to calculate the final score for the Organization Culture Fit. The candidate management computing device 60 then calculates the Similar Work Score for each of the plurality of the candidates based on the formula (A3+B3+C3+D3) as described in step 340.

Post the calculation of the Similar Work Score for each of the plurality of the candidates, the candidate management computing device 60 calculates a Social Personality score for each of the candidates based on the created company profile, job profile and the candidate profile, as described in FIG. 5, although other approaches for determining this score can be used. In some embodiments, the candidate management computing device 60 first retrieves the created company profile, job profile and the candidate profile as shown in step 310. Next, the candidate management computing device 60 calculates the Social Personality score for each of the candidates based on the data present in the retrieved company profile, job profile and candidate profile, although other approaches for determining this score can be used. As an example, by running a standard semantic analyzer, sentiment analyzer and specified keyword searches on the retrieved candidate profile data while comparing to the company and job profile, relevant domain and technology areas for the job and company are identified along with candidate parameters derived out of social network analysis on sites, like LinkedIn® or Facebook® by way of example only. Next, as an example, the candidate management computing device 60 calculates the Social Personality Score based on the formula (A4+B4), where: A4 is computed by (value x*(number of positive tweets and comments made by candidate on the company−number of negative tweets and comments made by candidate on the company)) where x is a number like 10; and B4 is computed based on calculating Social Personality Analyzer score on a social network site like Facebook by way of example only for each of the plurality of the candidates, although other approaches for determining this score can be used. The Social Personality Analyzer score is based on a standard Big Five Personality Test which is used to calculate the personality of the candidate by analyzing the Facebook profile data. The different personality's analysis having the high and low score are described with examples in a table below.

| Personality trait | High scorers | Low scorers |
|---|---|---|
| Openness | Imaginative | Conventional |
| Conscientiousness | Organized | Spontaneous |
| Extraversion | Outgoing | Solitary |
| Agreeableness | Trusting | Competitive |
| Neuroticism | Prone to stress | Emotionally |
| | and worry | stable |

These personality scores are calculated by considering the language features used for comments, personal information available, internal status updates and activities on Facebook®, Linked-in®, Twitter® and other similar Social web-sites/blogs, although other approaches for determining this score can be used. B4 is now computed by the candidate management computing device 60 using the formula ((value x*Openness)+(value x*Conscientiousness)+(value x*Agreeableness)−(value x*Neuroticism)) where x is a number like 10. The values associated with Openness, Agreeableness, Conscientiousness and Neuroticism all range, by example, between 0 and 1 where 0 is a low scorer and 1 is a high scorer as depicted in table above. The candidate management computing device 60 then calculates the Social Personality Score for each of the plurality of the candidates based on the formula (A4+B4) as described in step 350, although other approaches for determining this score can be used. Now the candidate management computing device 60 calculates the company fitment score for each of the plurality of candidates based on the formula (Integrity Score+Innovativeness Score+Similar Work Score+Social Personality Score) as described in step 360 of FIG. 5.

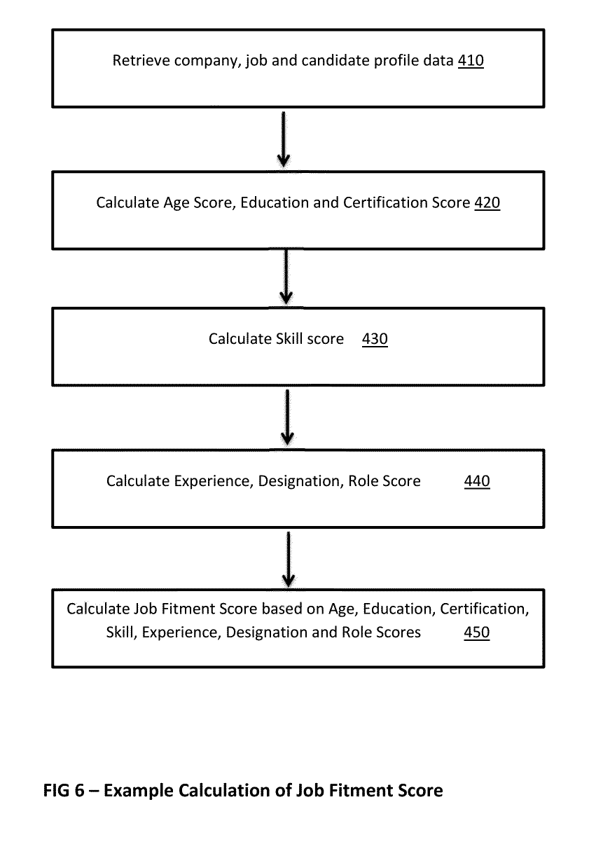

Post the calculation of the company fitment score for each of the plurality of the candidates, the candidate management computing device 60 calculates a job fitment score for each of the candidates based on the created company profile, job profile and the candidate profile, as described in FIG. 6. In some embodiments, the candidate management computing device 60 first retrieves the created company profile, job profile and the candidate profile as shown in step 410. Next, the candidate management computing device 60 calculates the Age score A1, Education score B1 and Certification score C1 for each of the candidates based on the data present in the retrieved company profile, job profile and candidate profile as described in step 420. As an example, by running a standard semantic analyzer, sentiment analyzer and specified keyword searches on the retrieved candidate profile data while comparing to the company and job profile, relevant domain and technology areas for the job and company are identified. Next, as an example, Age score A1 is computed using the formula (a value of 0 if candidate age does not match age provided in job description by company or a value of 1 if candidate age matches age provided in job description by company), although other approaches for determining this score can be used. Education score B1 is computed using the formula (a value of 0 if candidate education level does not match education level provided in job description by company or a value of 1 if candidate education level matches education level provided in job description by company), although other approaches for determining this score can be used. Certification score C1 is computed using the formula (value of x*number of certifications in relevant domain and technology areas) where x is a number like 10, although other approaches for determining this score can be used. Next the candidate management computing device 60 calculates a Skill score as described in step 430, based on years of experience of candidate and the proficiency of the candidate across different skills. As an example, the Skill score is calculated for each of the plurality of the candidates based on the formula (Σ{(total years of experience of the candidate)*(2*(proficiency rating in a skill self-declared by the candidate)*(proficiency rating of candidate in a skill given by the interviewer)/(proficiency rating in a skill self-declared by the candidate+proficiency rating of candidate in a skill given by the interviewer))}/Σ{(total years of experience required for the job as mentioned in the job description)*(required proficiency rating provided by company for a skill as mentioned in the job description)})/100, although other approaches for determining this score can be used. The proficiency rating, both self-declared by the candidate and provided by the interviewer will be a number ranging from 0 to 10 where 10 is the highest rating level and 0 is the lowest rating level. The required proficiency rating provided by a company for a skill will be a number ranging from 0 to 10 where 10 is the highest rating level and 0 is the lowest rating level. The Σ or summation is calculated across the various skills required in the job. Next, the candidate management computing device 60 calculates the Experience score D1, Designation score E1, Role score F1 as described in step 440. Experience score D1 is computed using the formula (a value of 0 if candidate experience level does not match experience level provided in job description by company or a value of 1 if candidate experience level matches experience level provided in job description by company), although other approaches for determining this score can be used. Next, Designation score E1 computed using the formula (a value of 0 if candidate designation does not match designation provided in job description by company or a value of 1 if candidate designation matches designation provided in job description by company), although other approaches for determining this score can be used. Next, Role score F1 is computed using the formula (value of x*number of keywords matched between candidate's roles and responsibility in past jobs and the company's job description) where x is a number like 10, although other approaches for determining this score can be used. Now the candidate management computing device 60 calculates the job fitment score for each of the plurality of candidates based on the formula (Age score+Education score+Certification score+Skill score+Experience score+Designation score+Role score) as described in step 450, although other approaches for determining this score can be used.

Post the calculation of the job fitment score for each of the plurality of the candidates, the candidate management computing device 60 calculates the Total Candidate Job score as described in step 170 of FIG. 3. The Total Candidate Job score for each of the plurality of the candidates is computed using the formula (X*Job Influence Score)+(Y*Company Fitment Score)+(Z*Job Fitment Score) where X, Y and Z are the weightage ratios in percentages input by the company or employer while creating job description, although other approaches for determining this score can be used. Next, the candidate management computing device 60 ranks the total list of candidates in order (either in descending or in ascending form) based on their calculated Total Candidate Job Score as described in step 180 of FIG. 3, although other approaches for ranking can be used.

The specification has described an example of a method and device for identifying a best fit candidate for a job. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, and/or deviations, by way of example only, of those described herein) will be apparent to persons skilled in the relevant art(s) based on the teachings contained herein. Such alternatives fall within the scope and spirit of the disclosed embodiments.

Furthermore, one or more non-transitory computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including programmed instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A method for identifying a best fit candidate for a job, the method comprising:
calculating, by a candidate management computing device, a job influence score, a company fitment score, and a job fitment score for each of a plurality of candidates for a job based on at least a company profile, a job profile, and a candidate profile;
determining, by the candidate management computing device, a total candidate job score for each of a plurality of candidates for a job based at least on the calculated job influence score, the company fitment score, and the job fitment score; and
ranking in order, by the candidate management computing device, the plurality of candidates for the job based on the calculated total candidate job score.

2. The method as set forth in claim 1 further comprising:
obtaining, by the candidate management computing device, company specific data and job specific data; and
creating, by the candidate management computing device, the company profile and the job profile based on the obtained company specific data and the job specific data.

3. The method as set forth in claim 2 wherein the obtained job specific data comprises at least one of a job description, a skill level, an education level, a geographical location or an experience level.

4. The method as set forth in claim 2 wherein the obtained company specific data comprises at least one of a company type, a company size, a geographical location, a service offering or a technology domain.

5. The method as set forth in claim 2 wherein creating the company profile and the job profile further comprises:
applying, by the candidate management computing device, a weightage ratio to each of the company fitment score, job fitment score, and the job influence score.

6. The method as set forth in claim 1 further comprising:
obtaining, by the candidate management computing device, data pertaining to each of the plurality of candidates for the job collected by a company associated with the job and from one or more of a social networking data source, a government data source, an industry based data source, or a job portal data source; and
generating, at the candidate management computing device, the candidate profile for each of the plurality of candidates based on the obtained data pertaining to each of the plurality of candidates for the job.

7. The method as set forth in claim 6 wherein the data pertaining to each of the plurality of candidates for the job collected by a company associated with the job comprises at least one of an interviewer feedback of a candidate, a candidate resume, or a company evaluation data of a candidate.

8. A candidate management computing device, comprising:
a memory; and
a processor coupled to the memory and configured to execute programmed instructions stored in the memory, comprising:
calculating a job influence score, a company fitment score, and a job fitment score for each of a plurality of candidates for a job based on at least a company profile, a job profile, and a candidate profile;
determining a total candidate job score for each of a plurality of candidates for a job based at least on the calculated job influence score, the company fitment score, and the job fitment score; and
ranking in order the plurality of candidates for the job based on the calculated total candidate job score.

9. The device of claim 8, wherein the processor is further configured to execute programmed instructions stored in the memory for the creating further comprising:
obtaining company specific data and job specific data; and
creating the company profile and the job profile based on the obtained company specific data and the job specific data.

10. The device of claim 9, wherein the obtained job specific data comprises at least one of a job description, a skill level, an education level, a geographical location, or an experience level.

11. The device of claim 9, wherein the obtained company specific data comprises at least one of a company type, a company size, a geographical location, a service offering, or a technology domain.

12. The device of claim 9, wherein creating the company profile and the job profile further comprises applying a weightage ratio to each of the company fitment score, job fitment score, and the job influence score.

13. The device of claim 8, wherein the processor is further configured to execute programmed instructions stored in the memory for the obtaining further comprising:
obtaining data pertaining to each of the plurality of candidates for the job collected by a company associated with the job and from one or more of a social networking data source, a government data source, an industry based data source, or a job portal data source; and
generating the candidate profile for each of the plurality of candidates based on the obtained data pertaining to each of the plurality of candidates for the job.

14. The device of claim 13, wherein the data pertaining to each of the plurality of candidates for the job collected by a company associated with the job comprises at least one of an interviewer feedback of a candidate, a candidate resume, or a company evaluation data of a candidate.

15. A non-transitory computer readable medium having stored thereon instructions for identifying a best fit candidate for a job comprising machine executable code which when executed by a processor, causes the processor to perform steps comprising:
calculating a job influence score, a company fitment score, and a job fitment score for each of a plurality of candidates for a job based on at least a company profile, a job profile, and a candidate profile;
determining a total candidate job score for each of a plurality of candidates for a job based at least on the calculated job influence score, the company fitment score, and the job fitment score; and
ranking in order the plurality of candidates for the job based on the calculated total candidate job score.

16. The medium of claim 15, wherein the processor is further configured to execute programmed instructions stored in the memory for the creating further comprising:
obtaining company specific data and job specific data; and
creating the company profile and the job profile based on the obtained company specific data and the job specific data.

17. The medium of claim 16, wherein the obtained job specific data comprises at least one of a job description, a skill level, an education level, a geographical location, or an experience level.

18. The medium of claim 16, wherein the obtained company specific data comprises at least one of a company type, a company size, a geographical location, a service offering, or a technology domain.

19. The medium of claim 16, wherein creating the company profile and the job profile further comprises applying a weightage ratio to each of the company fitment score, job fitment score, and the job influence score.

20. The medium of claim 15, wherein the processor is further configured to execute programmed instructions stored in the memory for the obtaining further comprising:
obtaining data pertaining to each of the plurality of candidates for the job collected by a company associated with the job and from one or more of a social networking data source, a government data source, an industry based data source, or a job portal data source; and
generating the candidate profile for each of the plurality of candidates based on the obtained data pertaining to each of the plurality of candidates for the job.

21. The medium of claim 20, wherein the data pertaining to each of the plurality of candidates for the job collected by a company associated with the job comprises at least one of an interviewer feedback of a candidate, a candidate resume, or a company evaluation data of a candidate.
